(19) United States
(12) Patent Application Publication
(10) Pub. No.: US 2011/0036927 A1
(43) Pub. Date: Feb. 17, 2011

(54) LIQUID SPRAY BOTTLE WITH INTEGRALLY MOLDED LIQUID PASSAGEWAY AND RELATED METHODS

(76) Inventor: Eric L. Hensen, Great Falls, MT (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 12/856,018

(22) Filed: Aug. 13, 2010

Related U.S. Application Data
(60) Provisional application No. 61/234,007, filed on Aug. 14, 2009.

(51) Int. Cl. B05B 9/03

(52) U.S. Cl. 239/302; 29/592

(57) ABSTRACT

A spray bottle assembly may include a spray head including a spray pump and a spray head tube extending downwardly therefrom. The spray bottle assembly may also include a spray bottle having an open upper end receiving the spray head. The spray bottle may have a base and at least one sidewall extending upwardly therefrom. The at least one sidewall may have an integrally formed liquid passageway therein having an upper opening coupled in fluid communication with the spray head tube, and may have a lower liquid pick-up opening adjacent the base.

### RELATED APPLICATION

The present application is based upon previously filed copending provisional application Ser. No. 61/234,007, filed Aug. 14, 2009, the entire subject matter of which is incorporated by reference in its entirety.

### FIELD OF THE INVENTION

The present invention relates to the field of bottles, and, more particularly, to liquid spray bottles and related methods.

### BACKGROUND OF THE INVENTION

A spray bottle assembly is generally used to squirt, spray or mist a fluid. For example, a common use for a spray bottle assembly is to dispense a cleaner, a cosmetic, and a chemical. Another example of a common use of a spray bottle assembly is to mix down concentrates with water.

A typical spray bottle assembly, for example, includes a plastic spray bottle to hold the fluid coupled with a spray head to spray, mist, or otherwise deliver the fluid from the spray bottle. A plastic spray bottle may come in various sizes and shapes, may also come in various colors, and may also include custom printing thereon.

A typical spray head includes a positive displacement pump that acts on the fluid in the plastic spray bottle. The pump, which is powered by a user, draws liquid up a straight siphon tube from near a center bottom portion of the plastic spray bottle, and the liquid is forced out a nozzle. The straight siphon tube extends downwardly straight from the trigger assembly. Depending on the sprayer, the nozzle may or may not be adjustable, so as to select between squirting a stream, aerosolizing a mist, or dispensing a spray.

A spray bottle assembly is increasingly popular because of its relatively low cost of production, durability, and ease of use. As a result of its reduced cost and ease of use, a spray bottle assembly is generally discarded when the liquid within the plastic spray bottle nears depletion. Attempts to deplete or use residual liquid within spray bottle often involve a user operating the spray bottle assembly in an awkward direction, for example facing upward, and often do not result in a complete removal of the liquid. Thus, the spray bottle assembly is generally discarded with residual liquid waste therein resulting in an increased usage cost for the user.

Moreover, discarding of spray bottle assemblies contributes to environmental pollution by creating an increased amount of solid waste and a potentially hazardous waste stream. Moreover, residual liquid waste within the spray bottle when the spray bottle assembly is discarded may further contribute to the creation of hazardous waste and pollution.

U.S. Patent Application Publication No. 2007/0241139 to Shade discloses a liquid spray bottle having a base and a partition adjacent the base. The liquid spray bottle includes four sidewalls, and the partition is impermeable and adjacent the sidewalls along three edges. A fourth edge is open. A spray head includes a spray head tube extending downwardly from a spray head pump and adjacent the open edge. The spray head tube extends along the base to the sidewall opposing the open edge.

U.S. Patent Application Publication No. 2008/0023499 to Knight discloses a liquid spray bottle having a base and sidewalls extending from the base to define a hollow interior. The base has a rounded indentation directed inwardly toward the hollow interior and sloped toward a given sidewall. A spray head includes a spray head tube extending downwardly from a spray head pump. The spray head tube is long enough to extend to the base and bend to a direction of the given sidewall.

### SUMMARY OF THE INVENTION

In view of the foregoing background, it is therefore an object of the present invention to provide a reusable liquid spray bottle assembly for removing an increased amount of liquid therefrom.

This and other objects, features, and advantages in accordance with the present invention are provided by a spray bottle assembly which may include a spray head including a spray pump and a spray head tube extending downwardly therefrom. The spray bottle assembly may also include a spray bottle having an open upper end receiving the spray head, for example. The spray bottle may have a base and at least one sidewall extending upwardly therefrom. The at least one sidewall may have an integrally formed liquid passageway therein having an upper opening coupled in fluid communication with the spray head tube, and may have a lower liquid pick-up opening adjacent the base, for example. Accordingly, the spray bottle assembly is reusable and advantageously removes an increased amount of liquid from the spray bottle.

The spray head tube may be slidably received in the upper opening of the liquid passageway, for example. The spray bottle assembly may further include an intermediate coupling tube extending between the spray head tube and the upper opening of the integrally formed liquid passageway. The intermediate coupling tube may be configured to permit rotation of the spray head relative to the spray bottle, for example.

The base may have a tilted inner floor to direct liquid toward the lower liquid pick-up opening of the integrally formed fluid passageway, for example. The at least one sidewall may include opposing front and rear sidewalls extending upwardly from the base. The front sidewall may have the integrally formed fluid passageway therein, for example. The at least one sidewall may also include opposing left and right sidewalls also extending upwardly from the base and coupled to the front and rear sidewalls.

The spray head may be configured to spray liquid in a direction outwardly from the front sidewall. The spray bottle may include an integrally molded plastic spray bottle, for example. The liquid pick-up opening may have a slanted shape, for example.

The spray head may include a spray head housing carrying the spray pump, and a trigger carried by the spray head housing and coupled to the spray pump. The spray head may also include a spray nozzle carried by the spray head housing and coupled to the spray pump, for example. The spray head may further include a threaded collar carried by the spray head housing. The open upper end of the spray bottle may be threaded, for example.

A method aspect is directed to a method of making a spray bottle assembly. The method may include providing a spray head including a spray pump and a spray head tube extending downwardly therefrom. The method may also include integrally forming a spray bottle to have an open upper end for receiving the spray head, and a base, for example. The spray bottle may be also integrally formed to have at least one sidewall extending upwardly from the base, for example. The at least one sidewall may be integrally formed to have an integral liquid passageway therein having an upper opening to be coupled in fluid communication with the spray head tube, and having a lower liquid pick-up opening adjacent the base, for example.

### BRIEF DESCRIPTION OF THE DRAWINGS

FIG. 1 a side schematic view of a spray bottle assembly in accordance with the present invention.

FIG. 2 is a front schematic view of the spray bottle assembly of FIG. 1.

FIG. 3 is a top schematic view of the spray bottle of the spray bottle assembly of FIG. 1.

FIG. 4 is an enlarged schematic view of the spray bottle of the spray bottle assembly of FIG. 1.

FIG. 5 is a bottom schematic view of the spray head of the spray bottle assembly of FIG. 1.

FIG. 6 is an enlarged side schematic view of the spray head of the spray bottle assembly of FIG. 1.

FIG. 7 is a side schematic view of an uncoupled spray head and spray bottle of the spray bottle assembly of FIG. 1.

FIG. 8 is a side schematic view of a coupled spray head and spray bottle of the spray bottle assembly of FIG. 1.

FIG. 9 is an enlarged schematic view of the coupling of the spray head tube, intermediate coupling tube, and integrally formed liquid delivery passageway of the spray bottle assembly of FIG. 1.

FIG. 10 is a side schematic view of another embodiment of a spray bottle assembly in accordance with the present invention.

FIG. 11 is a front schematic view of the spray bottle assembly of FIG. 10.

FIG. 12 is a flow chart illustrating a method of making a spray bottle assembly in accordance with the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

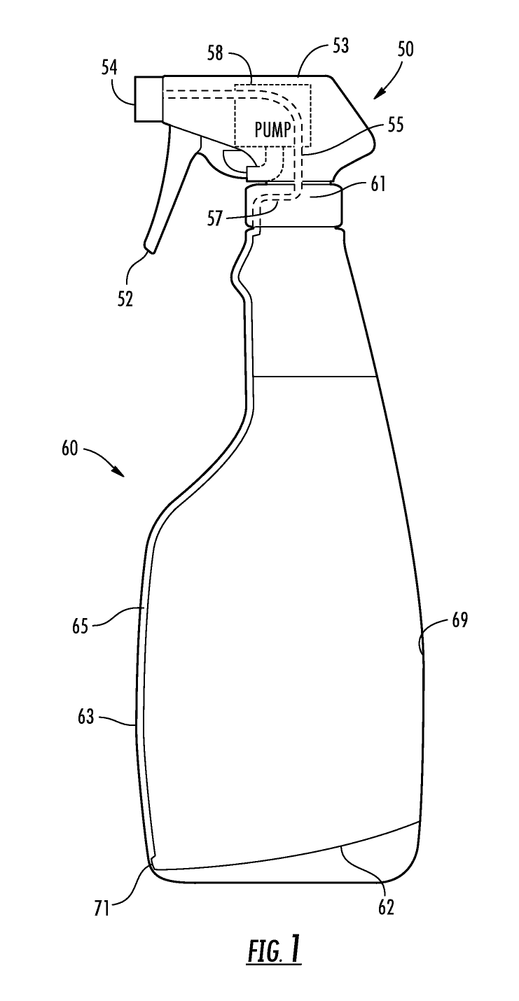

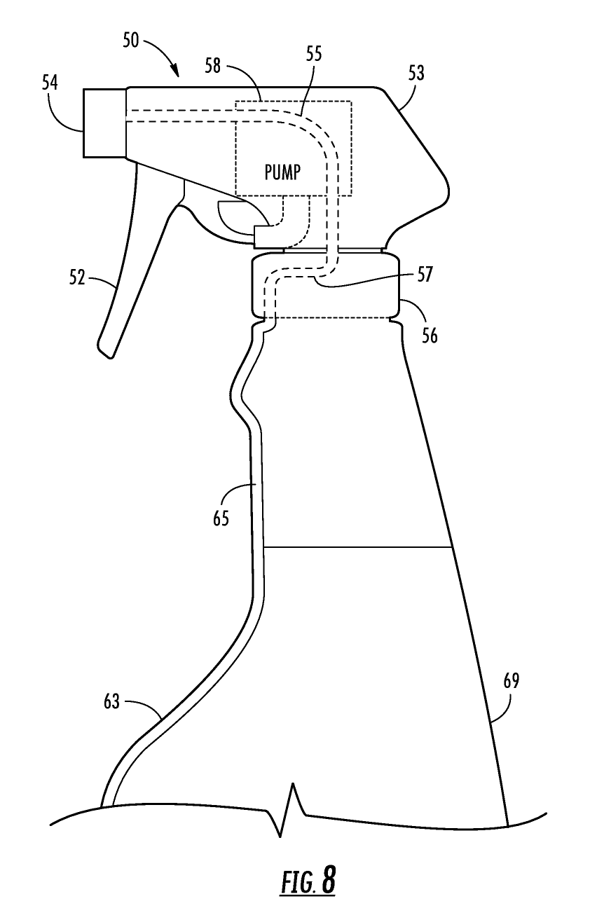

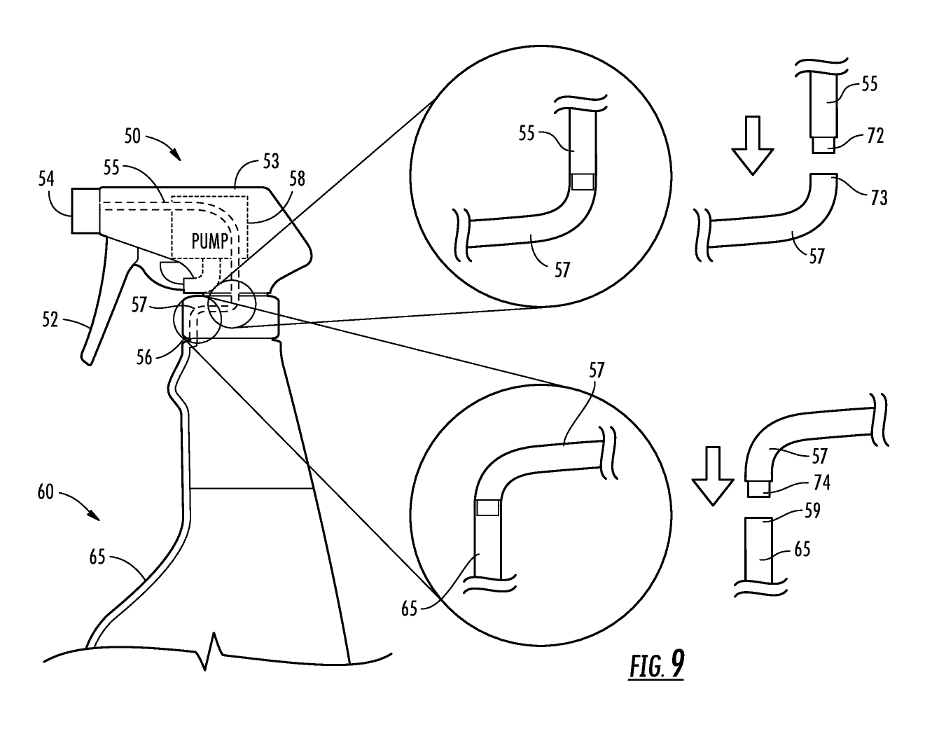

Referring initially to FIGS. 1-9, a spray bottle assembly 40 illustratively includes a spray head 50 coupled to a spray bottle 60. The spray bottle 60 is illustratively a plastic spray bottle, but may be other materials, as will be appreciated by those skilled in the art. The spray bottle 60 includes a base 62 and opposing front and rear sidewalls 63, 69 extending upwardly from an outer portion of the base. The front sidewall 63 opposes a user during use, and the opposing rear sidewall 69 faces the user during use. In other words, the spray head 50 is configured to spray liquid in a direction outwardly from the front sidewall 63. As will be appreciated by those skilled in the art, a liquid spray may include a liquid stream, or a liquid pattern, for example.

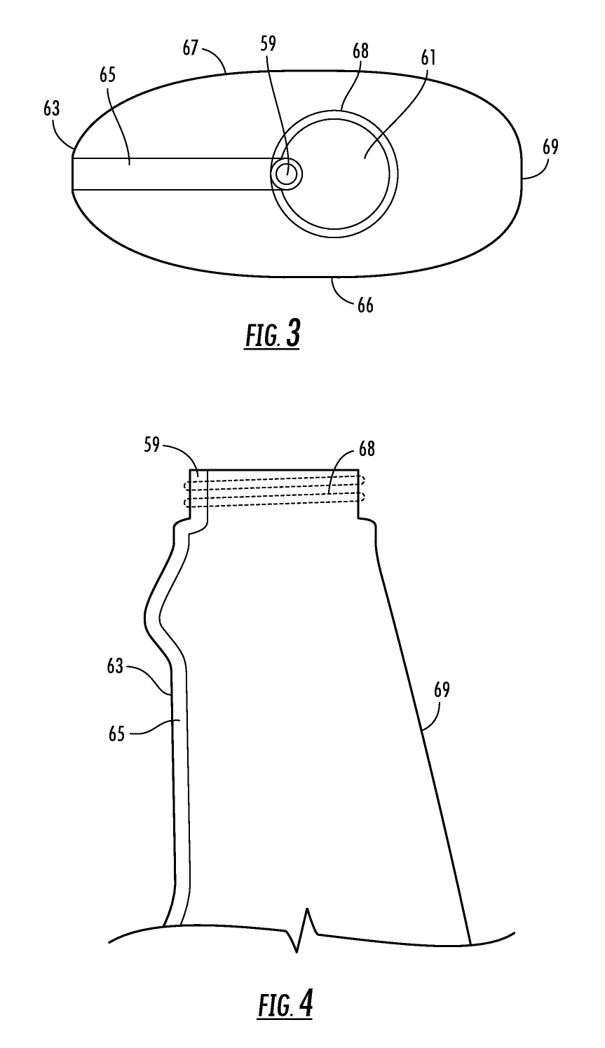

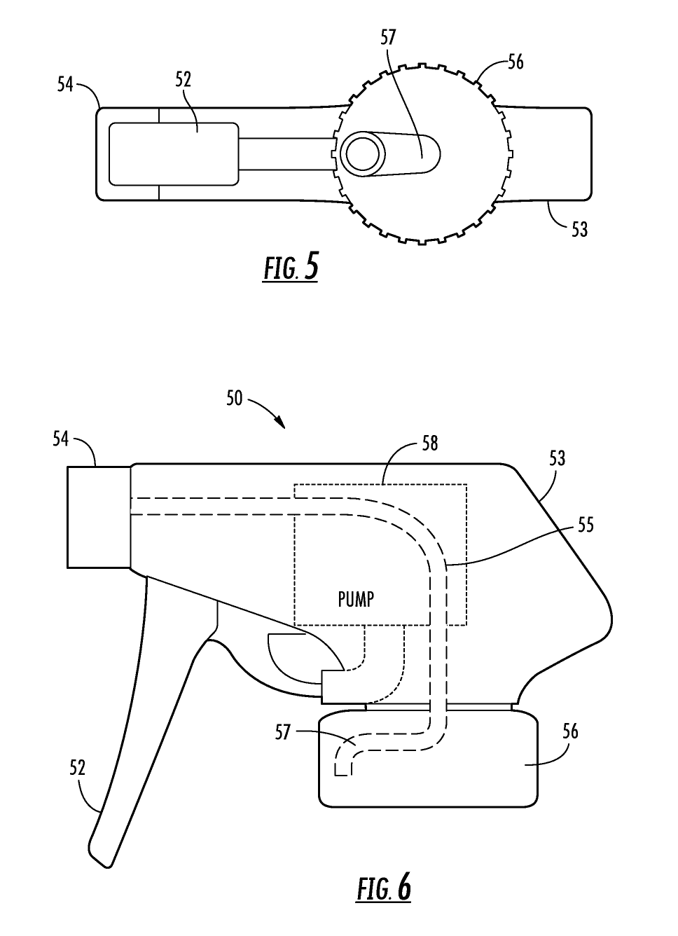

Opposing left and right sidewalls 66, 67 are transverse to the front and rear sidewalls 63, 69 and also extend upwardly from the base 62. The front and rear sidewalls 63, 69, and the left and right sidewalls 66, 67 extend upwardly from the base 62 to define a spray bottle opening open upper end 61. An outer upper portion 68 of the spray bottle adjacent the open upper end 61 is illustratively round and threaded for coupling to the spray head 50 (FIGS. 3 and 4). Other coupling mechanisms may be used as will be appreciated by those skilled in the art.

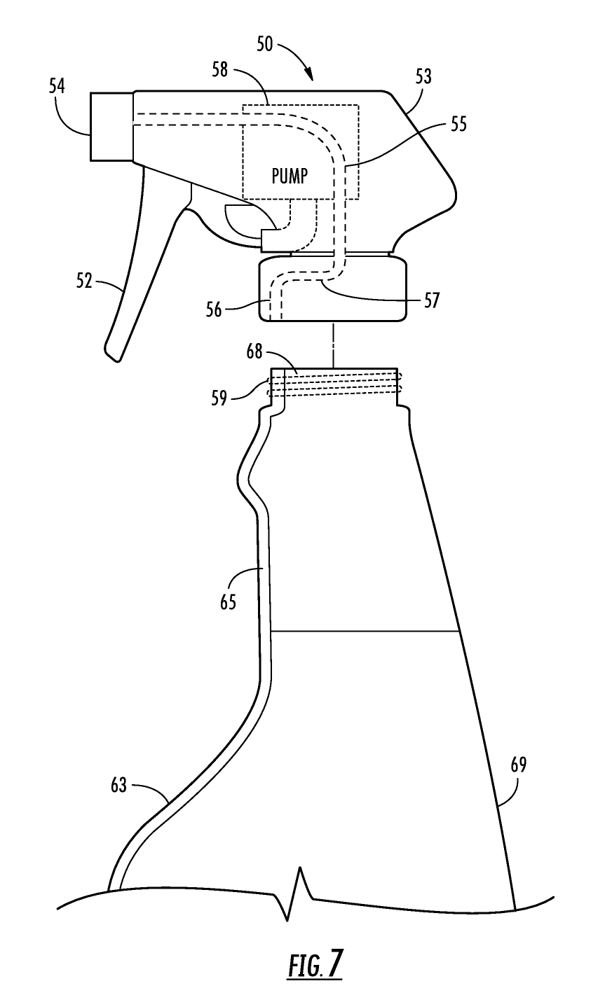

The spray head 50 illustratively includes a trigger 52 carried by a spray head housing 53. The spray head 50 also includes a nozzle 54 carried by the spray head housing 53. The trigger 52, nozzle 54, and a spray pump 58 cooperate similarly to a conventional trigger assembly, as will be appreciated by those skilled in the art. A spray head tube 55 extends downwardly from the nozzle 59 and spray pump 58. The spray head 50 further includes a threaded collar 56 (FIGS. 5 and 6) coupled to the spray head housing 53 and is rotatably mateable with the threaded outer upper portion 68 of the spray bottle 60.

The spray bottle 60 also illustratively includes an integrally formed or molded liquid passageway 65 along the front sidewall 63. The integrally formed liquid passageway 65 is positioned along the front sidewall 63 and extends from adjacent the spray bottle open upper end 61 to adjacent the base 62. The integrally formed liquid passageway 65 has an upper opening 59 coupled in fluid communication with the spray head tube 55 (FIGS. 3 and 4). The integrally formed liquid passageway 65 also has a lower liquid pick-up opening 71 adjacent the base 62. The lower liquid pick-up opening 71 is illustratively angled toward the center of the liquid spray bottle 60 for improving liquid flow through the vertical liquid delivery tube 65. The lower liquid pick-up opening 71 may be angled or shaped differently, as will be appreciated by those skilled in the art. The integrally formed liquid passageway 65 is illustratively round in shape, but may be formed in other shapes, such as a rectangle, for example.

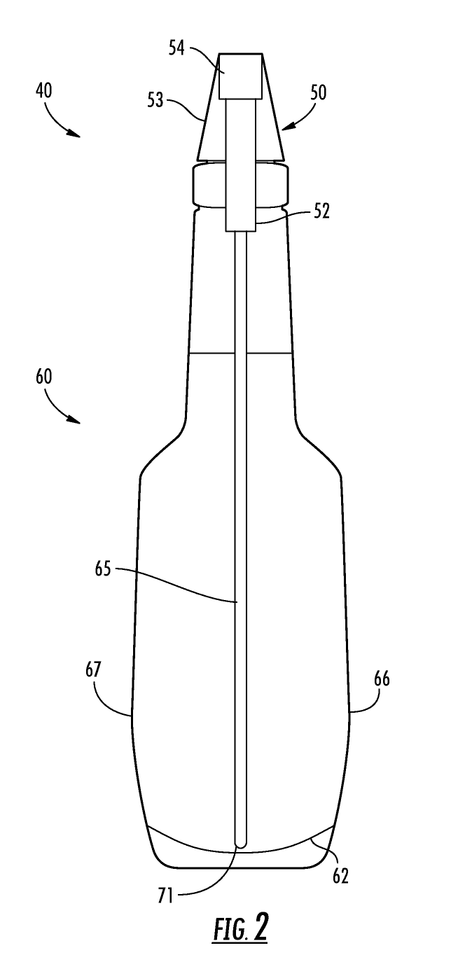

The spray bottle base 62 is illustratively has a tilted inner floor that is tilted from the rear sidewall 69 toward the front sidewall 63 (FIG. 1). Additionally, the base 62 is also illustratively tilted inwardly from the left and right sidewalls 66, 67 (FIG. 2). In other words, the spray bottle base 62 is tilted away from the left and right sidewalls 66, 67 and toward the front sidewall 63 to advantageously direct liquid in the spray bottle 60 toward the lower liquid pick-up opening 71 of the integrally formed liquid passageway 65. In other embodiments, the base 62 may be tilted from a center thereof to a periphery thereof and further tilted from the rear sidewall 69 toward the front sidewall 63. The shaping and sloping direction of the base 62 advantageously allows the liquid to be directed to the lower liquid pick-up opening 71 of the integrally formed liquid passageway 65 without angling the spray bottle assembly 40 in a direction to increase the amount of liquid collected near the integrally formed liquid passageway. Of course, other base tilting arrangement may be used, as will be appreciated by those skilled in the art.

The shaping and tilting direction of the base 62 is also particularly advantageous when a reduced amount of liquid remains in the spray bottle 60, as it reduces the amount of residual liquid remaining in the spray bottle prior to discarding. Thus, cost savings to the user and reduced pollution resulting from the residual liquid may result.

In some embodiments (not shown), the spray bottle 60 may be colored or opaque. In the embodiments where the spray bottle 60 may be colored, a portion of the spray bottle corresponding to the integrally formed liquid passageway 65 may be transparent to allow a user to see a liquid level within the spray bottle.

Indeed, as will be appreciated by those skilled in the art, the liquid spray bottle 60, including the vertical liquid delivery tube 65 may be formed as a monolithic unit, and may be formed using a plastic material. Other materials may be used to form the liquid spray bottle 60, as will be appreciated by those skilled in the art. The liquid spray bottle 60 may be formed from a die, or formed using a blow molding process. Other processes may also be used, as will be appreciated by those skilled in the art.

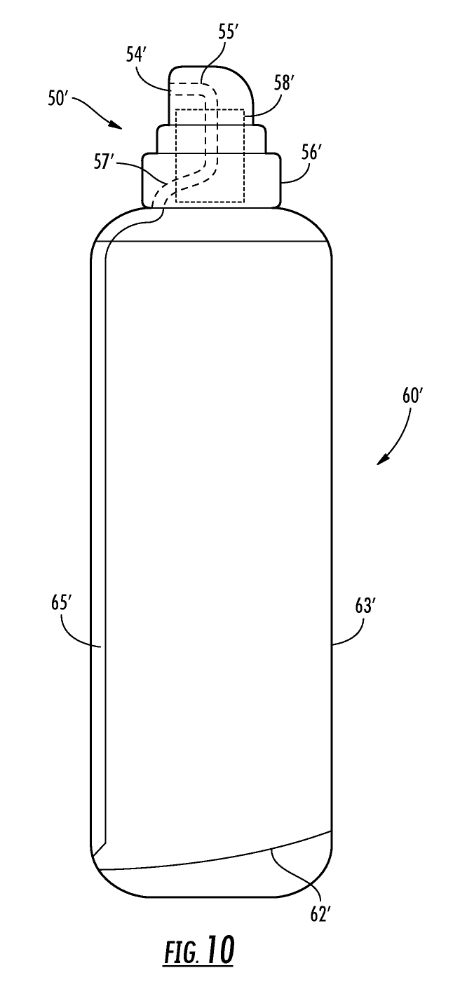

Referring more particularly to FIG. 9, an intermediate coupling tube 57 extends between the spray head tube 55 and the upper opening 59 of the integrally formed liquid passageway 65. The intermediate coupling tube 57 advantageously is positioned within the threaded collar 56 and is configured to permit rotation of the spray head 50 relative to the spray bottle 60. In other words, the intermediate coupling tube 57 allows the spray head 50 to rotate about an axis of rotation, which is illustratively a center of the threaded collar 56, or the spray head tube 55.

The spray head tube 55 illustratively includes a reduced diameter male end portion 72. The intermediate coupling tube 57 includes a female end portion 73 that receives the reduced diameter male end portion 72 of the spray head tube 50 therein. Of course, other coupling arrangements that allow rotation of the spray head housing 53 may be used, as will be appreciated by those skilled in the art. Also, the spray head tube 55, the intermediate coupling tube 57, including their respective ends, may be other shapes, or may be a combination of shapes.

In some embodiments, (not shown), the reduced diameter male end portion 72 of the spray head tube 55 includes an outwardly extending fluid-tight coupling feature therefrom for coupling with the female end portion 73 of the intermediate coupling tube 57. For example, the female end portion 73 of the intermediate coupling tube 57 may include a notch cut out from an inside portion thereof to couple with the outwardly extending coupling feature of the spray head tube 55. Other coupling features may be used, as will be appreciated by those skilled in the art.

The intermediate coupling tube 57 extends toward a peripheral outer portion of the threaded collar 56 and downwardly therefrom to couple with the integrally formed liquid passageway 65. Illustratively, the bottom intermediate coupling tube 57 is an “S” shape and extends downwardly after extending laterally and adjacent the threaded collar 56. In some embodiments, (not shown) the intermediate coupling tube 57 may extend downwardly past the lower portion of the threaded collar 56 for coupling with the integrally formed liquid passageway 65.

A male end portion 74 of the intermediate coupling tube 57 couples with the integrally formed liquid passageway 65 and also has reduced diameter for coupling. The reduced diameter male end portion 74 of the intermediate coupling tube 57 is coupled in fluid communication with the upper opening 59 of the integrally formed liquid passageway 65 to allow fluid from adjacent the base 62 of the spray bottle 60 to flow therethrough and be dispensed from the nozzle 54.

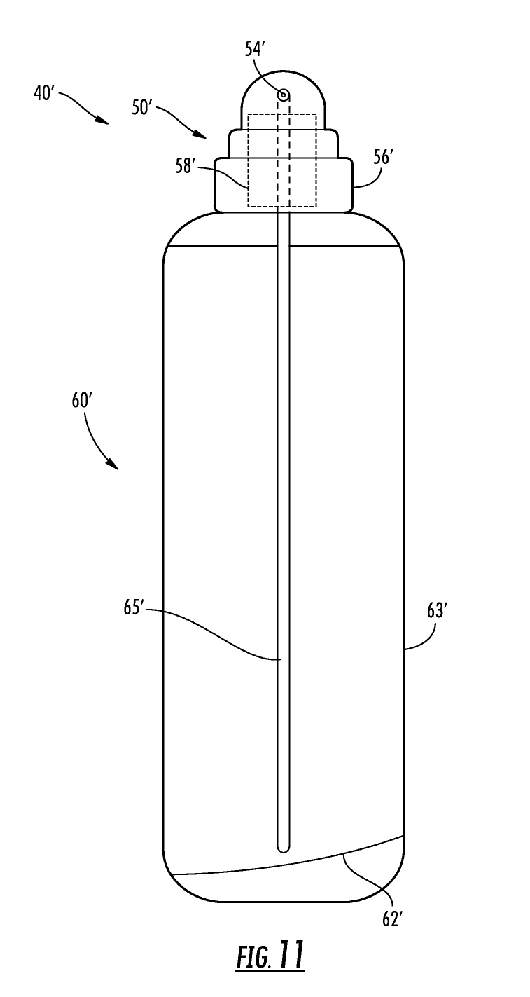

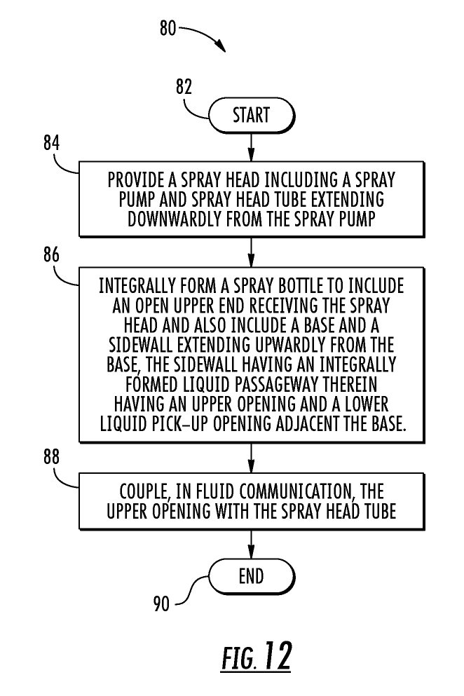

Referring now to FIGS. 10 and 11, in some embodiments, the spray bottle assembly 40′ may include a round spray bottle 60′ and a spray head 50′. In this embodiment, since there is a continuous sidewall 63′, i.e. no opposing front and rear, and left and right sidewalls, during operation, the nozzle 54′ may be longitudinally aligned with the integrally formed liquid passageway 65′ for improved removal of residual liquid within the round spray bottle 60′.

In some embodiments (not shown), a fluid manifold may be coupled to the integrally formed liquid passageway 65 adjacent the spray bottle base 62. The fluid manifold may include at least two downward facing openings therein adjacent the spray bottle base. In other embodiments, the fluid manifold may be integrally molded into the spray bottle base 62. The fluid manifold may advantageously increase the amount of fluid flowing through the integrally formed liquid passageway 65, and decrease the amount of residual liquid, as will be appreciated by those skilled in the art.

Indeed, the spray bottle assembly 40 advantageously reduces the residual liquid in the spray bottle prior to discarding and allows re-use of the spray bottle and the trigger assembly. For example, a manufacturer of a liquid, for example, a glass cleaner, may provide a liquid filled spray bottle without a trigger assembly. This may reduce manufacturing costs, and thus, user costs. The spray bottle assembly 40 may further reduce user costs by reducing the residual liquid in the spray bottle prior to discarding. In other words, the user's unit cost would decrease.

Still further, solid waste and other pollution associated with spray bottle assemblies including any residual liquid would also be reduced. Additionally, the user would have an improved experience in that he would not have to angle, tilt, or orient the spray bottle assembly in an awkward and difficult direction, as is often done to reduce the amount of residual liquid.

Referring now to the flowchart 80 in FIG. 12, a method aspect is directed to a method of making a spray bottle assembly 40. The method begins at Block 82 and includes providing a spray head 50 including a spray pump 58 and spray head tube 55 extending downwardly from the spray pump (Block 84). The method further includes integrally forming a spray bottle 60 to include an open upper end 61 receiving the spray head 50. The spray bottle 60 is also formed to include a base 62 and sidewalls 63, 66, 67, 69 extending upwardly from the base. One of the sidewalls 63 is formed to have an integrally formed liquid passageway 65 therein having an upper opening 59. The integrally formed liquid passageway 65 also includes a lower liquid pick-up opening 71 adjacent the base 62. At Block 88 the method includes coupling in fluid communication, the upper opening 71 with the spray head tube 55. The method ends at Block 90. Of course, a spray bottle assembly may be made according to the method above for a spray bottle having a single sidewall, for example, a round spray bottle, as will be appreciated by those skilled in the art.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A spray bottle assembly comprising:
a spray head comprising a spray pump and a spray head tube extending downwardly therefrom; and
a spray bottle having an open upper end receiving said spray head, and comprising a base and at least one sidewall extending upwardly therefrom;
said at least one sidewall having an integrally formed liquid passageway therein having an upper opening coupled in fluid communication with said spray head tube, and having a lower liquid pick-up opening adjacent said base.

2. The spray bottle assembly according to claim 1, wherein said spray head tube is slidably received in the upper opening of the liquid passageway.

3. The spray bottle assembly according to claim 1, further comprising an intermediate coupling tube extending between the spray head tube and the upper opening of the integrally formed liquid passageway.

4. The spray bottle assembly according to claim 3, wherein said intermediate coupling tube is configured to permit rotation of said spray head relative to said spray bottle.

5. The spray bottle assembly according to claim 1, wherein said base has a tilted inner floor to direct liquid toward said lower liquid pick-up opening of the integrally formed fluid passageway.

6. The spray bottle assembly according to claim 1, wherein said at least one sidewall comprises:
opposing front and rear sidewalls extending upwardly from said base, the front sidewall having the integrally formed fluid passageway therein; and
opposing left and right sidewalls also extending upwardly from said base and coupled to said front and rear sidewalls.

7. The spray bottle assembly according to claim 6, wherein said spray head is configured to spray liquid in a direction outwardly from the front sidewall.

8. The spray bottle assembly according to claim 1, wherein said spray bottle comprises an integrally molded plastic spray bottle.

9. The spray bottle assembly according to claim 1, wherein the lower liquid pick-up opening has a slanted shape.

10. The spray bottle assembly according to claim 1, wherein said spray head comprises:
a spray head housing carrying said spray pump;
a trigger carried by said spray head housing and coupled to said spray pump; and
a spray nozzle carried by said spray head housing and coupled to said spray pump.

11. The spray bottle assembly according to claim 10, wherein said spray head further comprises a threaded collar carried by said spray head housing; and wherein the open upper end of said spray bottle is threaded.

12. A spray bottle assembly comprising:
a spray head comprising a spray pump and a spray head tube extending downwardly therefrom; and
an integrally molded plastic spray bottle having an open upper end receiving said spray head, and comprising a base and at least one sidewall extending upwardly therefrom;
said at least one sidewall having an integrally formed liquid passageway therein having an upper opening coupled in fluid communication with said spray head tube, and having a lower liquid pick-up opening adjacent said base;
said base having a tilted inner floor to direct liquid toward said lower liquid pick-up opening of the integrally formed fluid passageway.

13. The spray bottle assembly according to claim 12, wherein said spray head tube is slidably received in the upper opening of the liquid passageway.

14. The spray bottle assembly according to claim 12, further comprising an intermediate coupling tube extending between the spray head tube and the upper opening of the integrally formed liquid passageway.

15. The spray bottle assembly according to claim 14, wherein said intermediate coupling tube is configured to permit rotation of said spray head relative to said spray bottle.

16. The spray bottle assembly according to claim 12, wherein said at least one sidewall comprises:
opposing front and rear sidewalls extending upwardly from said base, the front sidewall having the integrally formed fluid passageway therein; and
opposing left and right sidewalls also extending upwardly from said base and coupled to said front and rear sidewalls.

17. The spray bottle assembly according to claim 16, wherein said spray head is configured to spray liquid in a direction outwardly from the front sidewall.

18. The spray bottle assembly according to claim 12, wherein said spray head comprises:
a spray head housing carrying said spray pump;
a trigger carried by said spray head housing and coupled to said spray pump; and
a spray nozzle carried by said spray head housing and coupled to said spray pump.

19. A method of making a spray bottle assembly comprising:
providing a spray head comprising a spray pump and a spray head tube extending downwardly therefrom;
integrally forming a spray bottle to have
an open upper end for receiving the spray head,
a base, and
at least one sidewall extending upwardly from the base,
the at least one sidewall being integrally formed to have an integral liquid passageway therein having an upper opening to be coupled in fluid communication with the spray head tube, and having a lower liquid pick-up opening adjacent the base.

20. The method according to claim 20, wherein integrally forming the spray bottle comprises integrally forming the spray bottle to slideably receive the spray head tube in the upper opening of the integrally formed liquid passageway.

21. The method according to claim 20, further comprising coupling an intermediate tube between the spray head tube and the upper opening of the integrally formed liquid passageway.

22. The method according to claim 20, wherein the intermediate coupling tube is configured to permit rotation of the spray head relative to the spray bottle.

23. The method according to claim 20, wherein forming the spray bottle comprises forming the spray bottle to have the base have a tilted inner floor to direct liquid toward the lower liquid pick-up opening of the integrally formed fluid passageway.

24. The method according to claim 20, wherein the at least one sidewall comprises:
opposing front and rear sidewalls extending upwardly from the base, the front sidewall having the integrally formed fluid passageway therein; and
opposing left and right sidewalls also extending upwardly from the base and coupled to the front and rear sidewalls.

25. The method according to claim 20, wherein the forming the spray bottle comprises forming an integrally molded plastic spray bottle.
